(19) United States
(12) Patent Application Publication
(10) Pub. No.: US 2007/0160742 A1
(43) Pub. Date: Jul. 12, 2007

(54) Methods and materials for inhibiting the development of warmed-over flavor in meat

(76) Inventor: C. Terry Plum, Dallas, TX (US)

Correspondence Address: John A. Thomas, L.B. 48, 13355 Noel Road, Dallas, TX, 75240-1518, US

(21) Appl. No.: 11/327,999

(22) Filed: Jan. 9, 2006

(51) Int. Cl. A23L 1/31

(52) U.S. Cl. 426/641

(57) ABSTRACT

A method of preparing a pre-cooked meat product having reduced warmed-over flavor on reheating includes mixing into the meat, prior to cooking, a composition comprising an MDA-suppressing composition, so that the MDA-suppressing substance is brought into substantial contact with meat lipids. The MDA-suppressing substance is a composition prepared by cooking a vegetable from the allium genus, such as onion with a edible oil.

### TECHNICAL FIELD

This disclosure relates to the inhibition of warmed-over flavor in meat and to the improvement of texture in commercially-processed precooked meat.

### BACKGROUND

It has been long known that meat (e.g., beef, poultry, pork, fish) which is cooked and then stored at refrigerated temperatures may develop a rancid or stale flavor. Development of such flavors may occur in a relatively short period of time, generally much shorter than the time required for spoiling of raw meat. This phenomenon has come to be known in the industry as “warmed-over flavor” (abbreviated “WOF”).

There are many contexts in which cooked meat is refrigerated and then reheated for consumption, for example, leftovers, school luncheons, microwavable dinners, airline foods, fast foods, delicatessen foods, parbaked and even frozen pizzas, and the like. Development of WOF can adversely affect the palatability of meat in all of these situations and thus poses a significant problem.

Various treatments have been proposed to address this problem. For example, the meat may be cured with agents such as nitrites or nitrates. For reasons which heretofore have not been entirely understood, cured meat does not generally develop WOF. However, curing tends to impart a salty, smoked flavor and is thus unacceptable in many contexts. Also, nitrites are thought to be fairly carcinogenic as they may be converted to nitrosamines at the gastric pH, thereby causing damage to DNA.

Other treatments that have been proposed include various marinades and coatings, all of which are only moderately effective and which usually have undesirable effects on flavor and texture.

Accordingly, there is a continuing need to develop materials and methods for treating meat to inhibit the development of WOF.

### FIGURES

FIG. 1 is a flow chart generally depicting the method of the preferred embodiment.

FIG. 2 is a chart illustrating an example of the suppression of TBA by the process of the preferred embodiment.

### DESCRIPTION

This application uses the term “meat” broadly to include flesh from numerous types of animals, such as mammals, fowl, fish, and also includes artificial or synthetic meats. In particular, the term includes such meats as beef, pork, mutton, chicken, turkey, seafood, and freshwater fish, shellfish, sausages, meat patties, and the like.

Development of WOF is known to be proportional to the concentration of water-soluble low molecular weight aldehydes, such as malondialdehyde (MDA), hexanal, heptanal and n-nona-3-6-dienal that are formed as degradation products of lipid hydroperoxides and impart the characteristic WOF to precooked meat. MDA is the most prevalent aldehyde and has been reported as accounting for 93.3% and 98.5% of white and dark chicken TBA-reactive substances, respectively.

It is known that MDA can be reliably determined using thiobarbituric acid (TBA), because TBA is a by-product of lipid oxidation. TBA-reactive substances are generally believed to be a reliable chemical index of WOF generation in refrigerated precooked meat. This disclosure describes methods of producing precooked meat products that maintain low levels of TBA, as measured by the presences of MDA. In general, meat is mixed with an MDA-suppressing substance prior to cooking, so as to bring the MDA-suppressing substance in substantial contact with meat lipids. The MDA-suppressing substance is preferably a mixture of a member of the allium genus, such as onion, leek, garlic, or shallot cooked at high temperature with any edible oil. A suitable product is “Allium,” the trade name for such a cooked-onion composition manufactured by Jon-Lin, Inc., of Colton, Calif. In the cooking process for the MDA-suppressing ingredient, the raw material, such as onion, is typically sprayed with oil and subjected to short-duration roasting in a natural-gas oven with a 1500-degree flame.

In another embodiment, a soy-protein isolate is added to the meat along with the MDA-suppressing substance, which enhances the suppression of MDA development. A suitable soy-protein isolate is SUPRO, manufactured by the Solae Company of St. Louis, Mo.

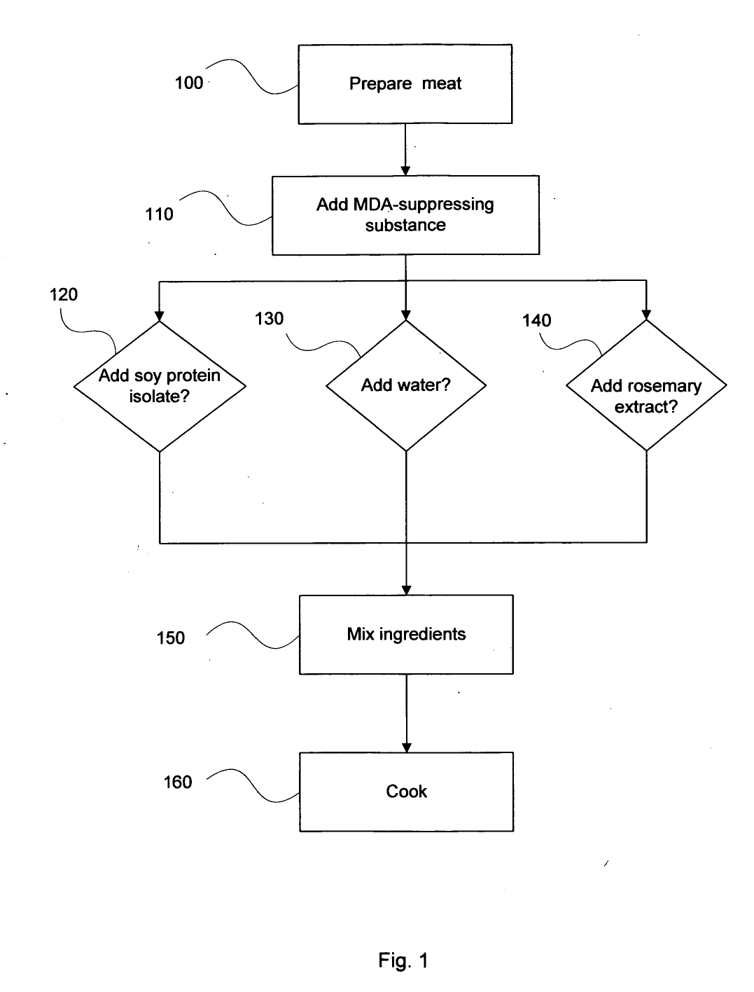

FIG. 1 shows a flow chart of the preferred embodiment, a process that produces the novel meat product. At step 100, the meat is ground. At step 110, the meat is mixed with the cooked-onion composition. At steps 120, 130, and 140, soy protein isolate, water, or rosemary extract are selectively added or not to the meat and cooked-onion composition mixture. At step 150, all of the ingredients just described are mixed, and the mixture is cooked at step 160. In commercial production, the resulting cooked product would be frozen for later consumption after reheating.

### EXAMPLE

This procedures in this example were carried out to determine development of TBA values and the texture of precooked, frozen, stored beef patties. Although beef was used in this example, the procedure is applicable to other meats. The formulae listed in Table 1 below were run in duplicate with the ingredients and procedures described. In the example, shown, the meat is ground; however, the MDA-suppressing substance can also be brought into substantial contact with meat lipids by other commercial preparation practices, such as injection along with a phosphate or brine solution.

Ingredients:

1. Beef meat.

2. MDA-suppressing ingredients (Allium, SUPRO 248, and rosemary).

3. Water.

3. Salt and pepper.

Preparation:

1. Beef was ground through 1″ plate.

2. Meat, MDA-suppressing ingredients (in combinations listed in Table 1), and water were mixed for one minute in paddle mixer (Talleres Cato; Espana, Spain; Model #AV5O).

3. Salt and pepper were added and mixed for 30 seconds.

4. Mixture was ground through ⅛″ plate.

5. Product was formed into 4/1 patties on Hollymatic (Model#300) patty former.

6. Patties were cooked in Enersyst Jet Sweep® Oven (Model #R.D.&D. II) with the following schedule to achieve a minimum internal temperature of 160° F.:

| Zone | Temp. ° F. | Time, sec | Steam |
|---|---|---|---|
| 1 | 350 | 90 | off |
| 2 | 350 | 60 | off |
| 3 | Ambient | 360 | on |

7. The product was placed in a single layer on trays, covered, and then placed in −20° F. freezer overnight.

8. The frozen precooked patties were bagged in poly-sleeves (20/sleeve), placed in a cardboard box, and kept frozen (in −20° F. freezer) until used for analysis.

9. Texture (10 patties each test) and TBA analyses (2 patties each test) were planned for day 1 then weeks 1, 4, and 12.

TABLE 1
Beef Patty Formulae Results

| | TEST 1 | | TEST 2 | | TEST 3 | |
|---|---|---|---|---|---|---|
| | Control | | SUPRO | | Rosemary | |
| Ingredients | Percent | kg | Percent | kg | Percent | kg |
| Beef 75/25 | 19.90 | 1.990 | 48.40 | 4.840 | 20.32 | 2.032 |
| Beef 81/19 | 79.10 | 7.910 | 41.60 | 4.160 | 78.50 | 7.850 |
| Allium | | | | | | |
| SUPRO | | | 2.00 | 0.200 | | |
| Water | | | 7.00 | 0.700 | | |
| Salt | 0.75 | 0.075 | 0.75 | 0.075 | 0.75 | 0.075 |
| Black Pepper | 0.25 | 0.025 | 0.25 | 0.025 | 0.25 | 0.025 |
| Rosemary | | | | | 0.18 | 0.018 |
| Extract | | | | | | |
| Total | 100.00 | 10.00 | 100.00 | 10.00 | 100.00 | 10.00 |
| Targeted % fat | 20.00 | | 20.00 | | 20.00 | |
| | TEST 4 | | TEST 5 | | TEST 6 | |
| | Rose. + SUPRO | | Allium | | Allium + SUPRO | |
| Ingredients | Percent | kg | Percent | kg | Percent | kg |
| Beef 75/25 | 48.82 | 35.70 | 64.20 | 6.420 | 3.570 | 4.882 |
| Beef 81/19 | 41.00 | 58.30 | 20.80 | 2.080 | 5.830 | 4.100 |
| Allium | | 5.00 | 5.00 | 0.500 | 0.500 | |
| SUPRO | 2.00 | | 2.00 | 0.200 | | 0.200 |
| Water | 7.00 | | 7.00 | 0.700 | | 0.700 |
| Salt | 0.75 | 0.75 | 0.75 | 0.075 | 0.075 | 0.075 |
| Black Pepper | 0.25 | 0.25 | 0.25 | 0.025 | 0.025 | 0.025 |
| Rosemary | 0.18 | | | | | 0.018 |
| Extract | | | | | | |
| Total | 100.00 | 100.00 | 100.00 | 10.00 | 10.00 | 10.00 |
| Targeted % fat | 20.00 | 20.00 | 20.00 | | | |

### Texture Analysis

Texture of the beef patties (g of force) were measured on a TAHDi texture analyzer with a Kramer-Shear attachment. Beef patties were tempered to room temperature (77° F.) prior to analysis.

### Oxidation Analysis

TBA (thiobarbituric acid) analysis, reported in ppm malonaldehyde and converted to TBA equivalents, was performed on each treatment at the intervals described in the procedure above. The results clearly show that TBA, and thus WOF, is substantially reduced over the control, to a commercially-acceptable level.

### Results

Texture analyses (Table 2) indicate no impact of Allium (T5 and T6) nor rosemary extract (T3 and T4) on beef patty texture/firmness when compared to the Standard all beef treatment (T1) after 4 and 12 weeks of frozen storage. The products containing soy protein isolate showed higher cook yields thus retaining more moisture and tended to be less firm (though not significantly) than their lower yielding, non-soy protein isolate containing counterparts (T1 vs T2; T3 vs T4; T5 vs T6).

TABLE 2

| | Cook | Force, g | Force, g | Force, g |
|---|---|---|---|---|
| Treatment | Yield | Wk I | Wk 4 | Wk 12 |
| T1-Standard | 64.9% | 23909 ^{a, b} | 23,616 ^{a} | 23,431 ^{a, b} |
| T2-SUPRO | 68.5% | 23,324 ^{a, b} | 21,680 ^{a} | 19,470 ^{a} |
| T3-Rosemary Extract | 65.7% | 26,245 ^{b} | 25,400 ^{a} | 26,079 ^{b} |
| T4- Rosemary + SUPRO | 69.9% | 25,228 ^{b} | 23,967 ^{a} | 23,581 ^{a, b} |
| T5-Allium | 66.1% | 24,954 ^{b} | 23,713 ^{a} | 22,240 ^{a, b} |
| T6-Allium + SUPRO | 68.5% | 20,770 ^{a} | 22,488 ^{a} | 22,951 ^{a, b} |

^{a, b} Means in the same column without a common superscript letter are significantly different (P < 0.05).

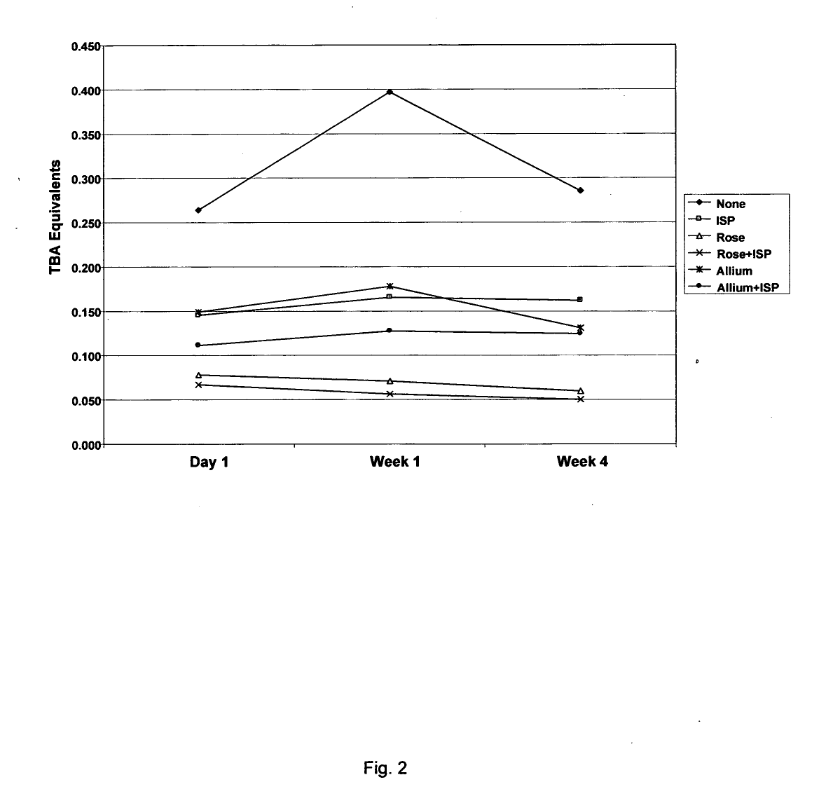

Compared to the Standard (T1), FIG. 2 shows all MDA-suppressing treatments had less fat oxidation after 12 weeks of frozen storage. Beef patties containing rosemary extract (T3 and T4) demonstrated a greater MDA-suppressing effect over the storage period thus far. However, use of rosemary extract imparts a strong flavor that is not desirable for many meat products, while the flavor of the cooked-onion composition is much less noticeable. Thus, the most useful treatments to reduce TBA and therefore WOF are the cooked-onion composition, or the same with the addition of soy protein isolate.

Since those skilled in the art can modify the specific embodiments described above, I intend that the claims be interpreted to cover such modifications and equivalents.

I claim:

1. A method of preparing a pre-cooked meat product having reduced warmed-over flavor on reheating, comprising:
mixing into the meat a composition comprising an MDA-suppressing composition;
so that the MDA-suppressing substance is brought into substantial contact with meat lipids; and,
cooking the meat.

2. The method of claim 1 further comprising grinding the meat before mixing in the MDA-suppressing composition.

3. The method of claim 1 where the mixing comprising injecting the MDA-suppressing substance into the meat.

4. The method of claim 1 where the MDA-suppressing substance comprises a cooked vegetable selected from the group of onion, garlic, leek, and shallot.

5. The method of claim 1 further comprising adding soy-protein isolate to the meat.

6. The method of claim 1 further comprising adding water to the meat.

7. The method of claim 1 further comprising adding rosemary extract to the meat.

8. A method of preparing a pre-cooked meat product having reduced warmed-over flavor on reheating, comprising:
grinding the meat;
mixing into the meat a composition comprising a cooked-onion composition; and,
cooking the meat.

9. The method of claim 8 further comprising adding soy-protein isolate to the meat.

10. The method of claim 8 further comprising adding water to the meat.

11. The method of claim 8 further comprising adding rosemary extract to the meat.

12. A pre-cooked meat product having reduced warmed-over flavor on reheating, the pre-cooked meat product having reduced warmed-over flavor on reheating prepared by a process comprising:
grinding the meat;
mixing into the meat a cooked-onion composition; and,
cooking the meat.

13. The product of claim 12 where the process further comprises adding soy protein isolate to the meat.

14. The product of claim 12 where the process further comprises adding water to the meat and composition.

15. The product of claim 12 where the process further comprises adding rosemary extract to the meat.

16. A pre-cooked meat product having reduced warmed-over flavor on reheating, the pre-cooked meat product having reduced warmed-over flavor on reheating prepared by a process comprising:
mixing into the meat a composition comprising an MDA-suppressing composition;
so that the MDA-suppressing substance is brought into substantial contact with meat lipids; and,
cooking the meat.

17. The method of claim 16 further comprising grinding the meat before mixing in the MDA-suppressing composition.

18. The method of claim 16 where the mixing comprising injecting the MDA-suppressing substance into the meat.

19. The method of claim 16 where the MDA-suppressing substance comprises a cooked vegetable selected from the group of onion, garlic, leek, and shallot.

20. The method of claim 16 further comprising adding soy-protein isolate to the meat.

21. The method of claim 16 further comprising adding water to the meat.

22. The method of claim 16 further comprising adding rosemary extract to the meat.

23. A method of reducing warmed-over flavor in pre-cooked meat comprising incorporating into the meat a composition comprising cooked-onion composition before cooking the meat.

24. The method of claim 23 further comprising adding soy protein isolate to the meat and composition.

25. The method of claim 23 further comprising adding water to the meat and composition.

26. The method of claim 23 further comprising adding rosemary extract to the meat and composition.

27. A method of reducing warmed-over flavor in pre-cooked meat comprising incorporating into the meat a cooked-onion composition and soy protein isolate before cooking the meat.

28. The method of claim 27 further comprising adding water to the meat and composition.

29. The method of claim 27 further comprising adding rosemary extract to the meat and composition.
